(19) United States
(12) Patent Application Publication
(10) Pub. No.: US 2025/0062553 A1
(43) Pub. Date: Feb. 20, 2025

(54) Electrical connection system

(71) Applicant: Weidmüller Interface GmbH & Co. KG, Detmold (DE)

(72) Inventors: Leon BÖDEKER, Lemgo (DE); Christian BEERMANN, Detmold (DE); Lars HÜSEMANN, Dörentrup (DE)

(21) Appl. No.: 18/804,538

(22) Filed: Aug. 14, 2024

(30) Foreign Application Priority Data
Aug. 18, 2023 (DE) 10 2023 122 129.9

(51) Int. Cl. H01R 9/26

(52) U.S. Cl. CPC H01R 9/2608

(57) ABSTRACT

An electrical connection system having at least one series terminal that can be positioned on a fixed support rail is configured such that the series terminal is arranged in a housing which has a closed base facing the support rail when in the mounted position and two side walls angled thereto which are arranged parallel go and spaced apart from one another. A latching member that can be latched to the support rail is provided on the exterior of the base, and a mounting member on which the series terminal is retained is provided on the interior of the base.

This application claims priority of DE 20 2023 122 129.9 filed Aug. 18, 2023. The entire content of this application is incorporated herein by reference.

### BACKGROUND OF THE INVENTION

The invention relates to an electrical connection system.

### BRIEF DESCRIPTION OF THE PRIOR ART

Such electrical connection systems are known from the prior art. In this regard, reference is made to DE 10 2012 016 094 A1 for example, which discloses an arrangement of series terminals which are each retained on a supporting plate.

To create air gaps and electrically isolated areas, the series terminals are positioned with a clear spacing from the associated supporting plate which requires a significant space. From time to time, spatial problems arise when a plurality of series terminals have to be mounted, particularly when the space available is not within the desired measurements.

In addition, it is not always possible to insure that the appropriate series terminal is attached to the supporting plate without shifting which can lead to functional problems under certain circumstances.

Existing connection systems are not suitable to meet for example the requirements regarding the air gaps and isolation according to Underwriters Laboratories (UL) 5.08A without adaptation or modification of the series terminals.

### SUMMARY OF THE INVENTION

The invention was developed to provide an electrical connection system of the generic type constructed as simply as possible, able to be mounted in a space-saving manner, and able to be produced inexpensively.

The electrical connection system includes at least one series terminal that can be positioned on a fixed support rail, wherein the series terminal is arranged in a housing which has a closed base facing the support rail when in the mounted position and two side walls angled thereto which are arranged parallel and spaced apart relative to one another. A latching member that can be latched to the base is provided on the outside of the base, and a mounting member on which the series terminal is retained is provided on the inside of the base.

The inventive configuration of the electrical connection system in which the at least one series terminal is arranged in a housing provides a space-saving arrangement on the support rail where the clearance of the two side walls corresponds to the associated thickness dimension of the series terminal.

The housing is not the housing of the series terminal per se in which its connection elements are accommodated. Rather, it is a type of enclosure in the sense of a receiving container for the entire series terminal. The term series terminal is used broadly. It can be an electronic component of various types that can be connected in series and has at least one conductor connection. The air gaps and isolation areas relative to adjacent series terminals can easily be kept particularly large by the respective enclosure.

The air gaps and isolation areas are preferably configured toward the support rail such that the spacing relative to the connection contacts of the series terminal is preferably greater than 25 mm. This measurement is determined by the mounting member which is provided on the inside of the base and on which the series terminal is retained.

In an assembly of at least two series terminals, the air gap and isolation area between the connection contacts of the adjacent series terminals is greater than 25 mm.

The length of the side walls, with regard to the connection contacts of the series terminal, like the height of the side walls, on the side opposite the support rail or on the side opposite the latching member of the housing, is preferably greater than 50 mm. The housing is formed from an electrically insulating material, preferably a plastic, as an injection-molded part which is inexpensive to manufacture.

The completion of the housing/series terminal structural unit can take place at the place of manufacture, with this structural unit being assembled by latching the housing to the support rail using the latching member arranged on the outside of the base.

The inner contour of the latching member corresponds to that of the foot of a standard series terminal but can also have any other suitable contour with which secure latching of the housing on the support rail is possible.

The contour of the mounting member provided on the inside of the base of the housing preferably corresponds to the contour of the support rail, at least such that secure latching is possible.

Except for the closed base, the housing is preferably circumferentially open, such that simple mounting of the series terminal in the housing is possible, together with unimpeded access to the connection contacts of the series terminal.

The configuration of the connection system according to the invention makes it possible to employ standard series terminals where this was previously not possible, in particular in the case of air gap and isolation requirements according to the UL5.08A, wherein the series terminals can be used in the respective grid dimensions for the feeder circuit according to the American UL.

### BRIEF DESCRIPTION OF THE FIGURES

An exemplary embodiment of the invention will be described below with the aid of the enclosed drawings, in which:

FIG. 1 is a partial sectional perspective view of a housing as part of the connection system according to the invention;

FIG. 2 is a bottom perspective view of the housing according to FIG. 1;

FIG. 3 is a front view of the housing;

FIG. 4 is a perspective view of a completed connection system; and

FIG. 5 is a side sectional perspective view of the connection system taken along line V-V of FIG. 4.

### DETAILED DESCRIPTION

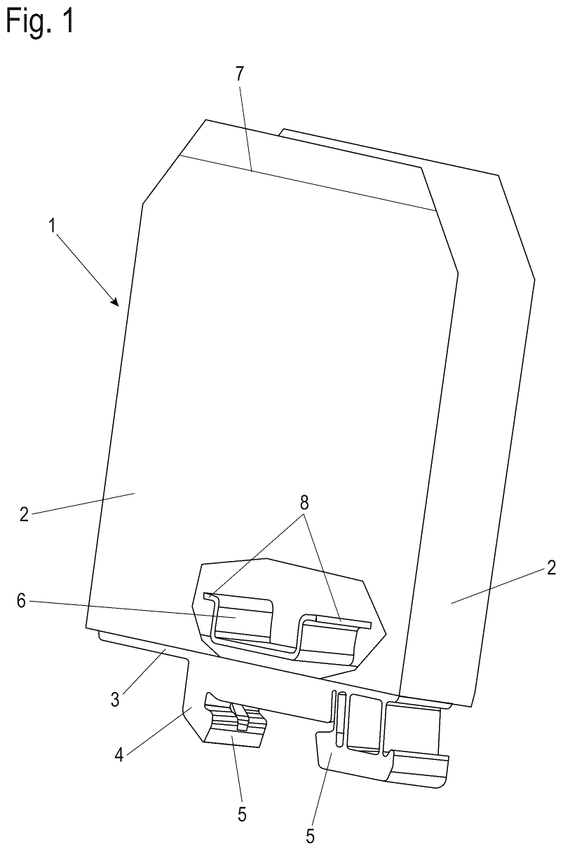

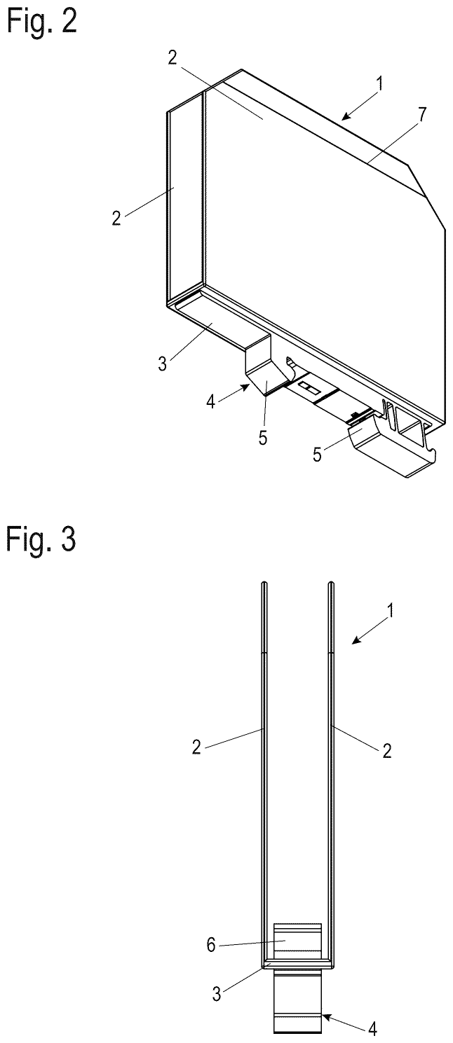

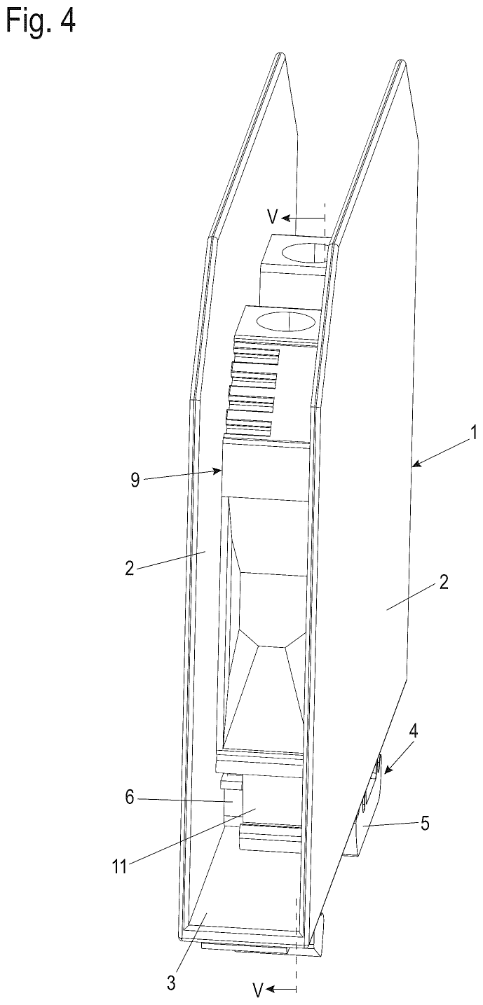

FIGS. 1-5 show a housing 1 for an electrical connection system according to an exemplary embodiment of the invention in which a series terminal 9 (shown in FIG. 4) is arranged.

With regard to the series terminal 9, the housing 1 is a type of enclosure similar to a receptacle. The housing 1 has a base 3 which two side walls 2 extend at an angle. The side walls are arranged parallel to and spaced from one another with the clearance therebetween corresponding to the allocated thickness of the series terminal or terminal block 9. The series terminal is preferably inserted into the housing without play. Depending on their nominal size, the terminal blocks have thicknesses of 3.5 mm, 5.1 mm, 6.1 mm, 8.1 mm, 10 mm or 12 mm, for example.

Except for the base 3, the housing 1 is open at the circumference, i.e. the interior of the housing 1 is accessible from three sides.

In the mounted position, the base 3 is arranged on the side of the housing 1 which faces a fixed support rail and is equipped with a latching member 4 for fitting on a support rail. The latching member includes latching limbs 5 which grip or latch over the support rail (not shown) which in cross section generally includes a crown portion with extensions on either side thereof.

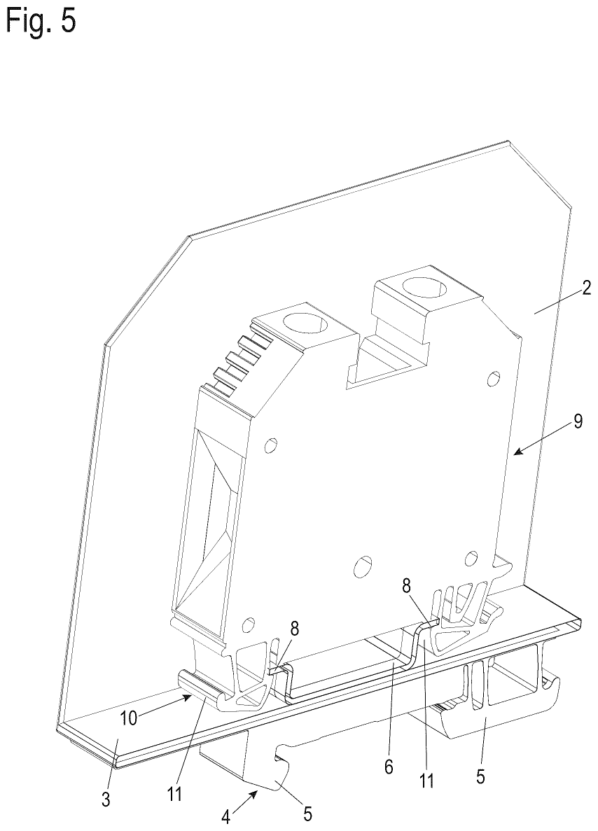

On the side of the base 3 opposite the latching member 4, i.e. on the inside of the base, there is provided a mounting member 6 whose cross-section corresponds to that of the support rail and on which the series terminal 9 is retained. More particularly, the series terminal is securely latched in a releasable manner by an appropriately shaped foot 10 which is adapted to engage the mounting member. The configuration of the mounting member 6 can be seen in FIGS. 1 and 5. The foot 10 has latching tabs 11 which grip under the outwardly angled latching strips 8 of the mounting member 6 and thus produce a positive fit.

As set forth above, the housing is made of plastic. It is preferably molded as one piece including the integral latching member 4 and the integral mounting base 6. A multi-piece design with joined individual parts is also possible.

The contour of the latching member 4 corresponds with the contour of the foot 10 of the series terminal 9, while the contour of the mounting base 6 corresponds to the contour of the support rail. However, other contours which differ are also possible depending on the structural conditions.

In order to achieve a lower overall height of the housing 1, a predetermined breaking point or area 7 running parallel to the base is provided on each side of the side walls 2 opposite the base 3. For example, a scoreline or other weakening of the housing material may be provided to define the breaking area.

Air gaps and isolation areas relative to adjacent series terminals are kept as large as possible by the respective enclosure of the housing. The air gaps and isolation areas are preferably configured toward the support rail such that the spacing relative to the connection contacts of the series terminal is preferably greater than 25 mm. This measurement is determined by the mounting member which is provided on the inside of the base and on which the series terminal is retained.

In an assembly of at least two series terminals, the air gap and isolation area between the connection contacts of the adjacent series terminals is greater than 25 mm.

The length of the side walls, with regard to the connection contacts of the series terminal, like the height of the side walls, on the side opposite the support rail or on the side opposite the latching member of the housing, is preferably greater than 50 mm.

What is claimed is:

1. An electrical connection system for mounting a series terminal on a support rail, comprising
(a) a housing having a closed base facing a support rail and two spaced, parallel side walls extending from said base;
(b) a latching member on an exterior of said base and configured for latching to the support rail; and
(c) a mounting member on an interior of said base and configured to retain the series terminal.

2. The electrical connection system as defined in claim 1, wherein a space between said side walls corresponds at least to a size of the series terminal.

3. The housing system as defined in claim 1, wherein said housing is open about its circumference with the exception of said base.

4. The electrical connection system as defined in claim 1, wherein said housing, said latching socle member and said mounting member are configured in one piece.

5. The electrical connection system as defined in claim 1, wherein said housing is formed of an insulating plastic material.

6. The electrical connection system as defined in claim 1, wherein an inner contour of said latching member corresponds with an inner contour of a foot portion of the series terminal which is retained on said mounting member in a form-fitting manner.

7. The electrical connection system as defined in claim 1, wherein an inner contour of said latching member corresponds with a contour of the support rail.

8. The electrical connection system as defined in claim 1 wherein a surface of said side walls is larger than a side surface the series terminal.

9. The electrical connection system as defined in claim 1, wherein a predetermined breaking point extending parallel to said base is defined on side wall surface facing away from said latching member.

10. The electrical connection system as defined in claim 1, wherein an an air gap and isolation of connection contacts between said base and an upper edge of side walls and transverse thereto is greater than 50 mm.

11. The electrical connection system as defined in claim 1, wherein an air gap and isolation between connection contacts of the series terminal and the support rail is greater than 25 mm.

12. The electrical connection system as defined in claim 1, wherein said housing and the series terminal are assembled into a structural unit at the place of manufacture.

13. An electrical connection system for mounting at least two adjacent series terminals on a support rail, comprising
(d) a housing having a closed base facing the support rail and two spaced, parallel side walls extending from said base;
(e) a latching member on an exterior of said base and configured for latching to the support rail; and
(f) a mounting member on an interior of said base and configured to retain the series terminals, an air gap and isolation between connection contacts of the adjacent series terminals is greater than 25 mm.
